(19) United States
(12) Patent Application Publication
(10) Pub. No.: US 2010/0274811 A1
(43) Pub. Date: Oct. 28, 2010

(54) DELAYED FILTERING OF ELECTRONIC COMMUNICATION

(76) Inventor: Nathaniel S. Borenstein, Southfield, MI (US)

Correspondence Address: HOFFMAN WARNICK LLC, 75 STATE STREET, 14TH FLOOR, ALBANY, NY, 12207, US

(21) Appl. No.: 12/428,662

(22) Filed: Apr. 23, 2009

(51) Int. Cl. G06F 7/06; G06F 15/16; G06F 17/30

(52) U.S. Cl. 707/783; 709/206; 707/E17.044; 707/E17.014

(57) ABSTRACT

The invention provides a method, system, and program product for processing an electronic communication by delaying its filtering in order to improve the effectiveness of such filtering. In one embodiment, the invention includes sequestering the electronic communication for a period of time, determining whether the electronic communication should be rejected based on either or both of its source or its content, in the case that the electronic communication should be rejected based on either or both of its source or its content, rejecting the electronic communication, and in the case that the electronic communication should not be rejected based on either or both of its source or its content, delivering the electronic communication to at least one recipient.

### FIELD OF THE INVENTION

The present invention relates generally to electronic communication and, more particularly, to the delayed filtering of an electronic communication to improve its effectiveness.

### BACKGROUND OF THE INVENTION

Electronic communication has proven a very valuable tool due, in part, to the speed and ease with which it may take place. Unfortunately, these aspects have been taken advantage of by spammers and more nefarious actors in an attempt to harm, harass, or annoy recipients of electronic communication. In response, various filtering mechanisms and systems have been developed to identify and remove such electronic communications before they reach their intended recipient(s). Typically, such mechanisms and systems rely on a reference database of senders or communication contents that have previously been determined to be illegitimate. Incoming communications are compared to these databases and, if a sender or a communication's contents are found in the database, the communication is marked as illegitimate and/or removed without being delivered to the recipient(s).

One disadvantage of such mechanisms and systems is that new illegitimate communications (i.e., communications not yet included in the reference database) are not marked as illegitimate and are often delivered to the recipient(s). Given the fact that many illegitimate communications are sent in bulk to hundreds or thousands of recipients at once, there is the potential that the illegitimate communication will, in fact, be delivered to a large proportion of the intended recipients before the illegitimate communication is added to the reference database. Thus, known mechanisms and systems are of little or no use in protecting an intended recipient of an illegitimate electronic communication if that intended recipient is sent the communication before it can be identified as illegitimate.

Accordingly, there exists a need in the art to overcome the deficiencies and limitations described hereinabove.

### SUMMARY OF THE INVENTION

The invention provides a method, system, and program product for processing an electronic communication by delaying its filtering in order to improve the effectiveness of such filtering.

A first aspect of the invention provides a method of processing an electronic communication, the method comprising: sequestering the electronic communication for a period of time; determining whether the electronic communication should be rejected based on either or both of its source or its content; in the case that the electronic communication should be rejected based on either or both of its source or its content, rejecting the electronic communication; and in the case that the electronic communication should not be rejected based on either or both of its source or its content, delivering the electronic communication to at least one recipient.

A second aspect of the invention provides a system for processing an electronic communication, the system comprising: a system for sequestering the electronic communication for a period of time; a system for determining whether the electronic communication should be rejected based on either or both of its source or its content; a system for rejecting the electronic communication; and a system for delivering the electronic communication to at least one recipient.

A third aspect of the invention provides a program product stored on a computer-readable medium, which when executed, processes an electronic communication, the program product comprising: program code for sequestering the electronic communication for a period of time; program code for determining whether the electronic communication should be rejected based on either or both of its source or its content; program code for rejecting the electronic communication; and program code for delivering the electronic communication to at least one recipient.

A fourth aspect of the invention provides a method for deploying an application for processing an electronic communication, comprising: providing a computer infrastructure being operable to: sequester the electronic communication for a period of time; determine whether the electronic communication should be rejected based on either or both of its source or its content; in the case that the electronic communication should be rejected based on either or both of its source or its content, reject the electronic communication; and in the case that the electronic communication should not be rejected based on either or both of its source or its content, deliver the electronic communication to at least one recipient.

The illustrative aspects of the present invention are designed to solve the problems herein described and other problems not discussed, which are discoverable by a skilled artisan.

### BRIEF DESCRIPTION OF THE DRAWINGS

These and other features of this invention will be more readily understood from the following detailed description of the various aspects of the invention taken in conjunction with the accompanying drawings that depict various embodiments of the invention, in which:

FIG. 1 shows a flow diagram of an illustrative method according to the invention; and

FIG. 2 shows a block diagram of an illustrative system according to the invention.

It is noted that the drawings of the invention are not to scale. The drawings are intended to depict only typical aspects of the invention, and therefore should not be considered as limiting the scope of the invention. In the drawings, like numbering represents like elements between the drawings.

### DETAILED DESCRIPTION OF THE INVENTION

As noted above, the invention provides a method, system, and program product for processing an electronic communication. More specifically, processing an electronic communication by delaying its filtering in order to improve the efficacy of such filtering.

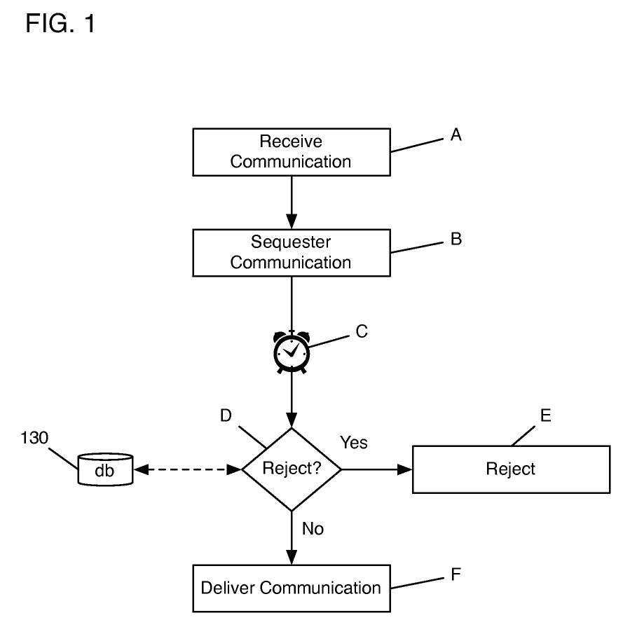

Turning now to the drawings, FIG. 1 shows a flow diagram of an illustrative method according to the invention. At A, an electronic communication is received. For purposes of illustration only, the electronic communication will be described herein as an electronic mail message. It should be recognized, however, that the invention is applicable to any electronic communication, including, for example, an instant messaging message, a text message, a facsimile transmission, a social networking message, etc.

At B, the electronic communication is sequestered. By “sequestered,” it is meant that the electronic communication is not delivered to a recipient. The electronic communication may be transferred to a designated device or location within a device or it may be simply held within the system that normally receives such communications. Following a sequestration period C, the electronic communication is processed (e.g., filtered) at D to determine whether it should be rejected. The sequestration period C will typically be pre-determined, although it need not be. If pre-determined, the sequestration period is preferably between about one hour and about 24 hours, more preferably between about one hour and about six hours, and still more preferably between about one hour and about three hours. If the sequestration period C is not pre-determined, it may be based on any number of criteria. For example, the sequestration period C may be the time between receipt of the communication and the next time the intended recipient accesses his/her communication program (e.g., his/her electronic mail client). In other embodiments of the invention, the sequestration period C may be some combination of a pre-determined and non-pre-determined period (e.g., sequestered until the recipient next accesses his/her electronic mail client, but not less than three hours from receipt of the communication). Other suitable criteria for the sequestration period are possible, of course, and are within the scope of the invention.

As noted above, at D, it is determined whether the electronic communication should be rejected. Such a determination may be made, for example, using any known or later-developed spam filter or similar filtering mechanism or system. Typically, the determination made at D will employ a database 130 of communication sources and/or contents that have been pre-determined should be rejected (e.g., a “blacklist”). Alternatively, or in addition, the determination made at D may employ a database of communication sources and/or contents that have been pre-determined should be delivered to the intended recipient(s) (e.g., a “whitelist”).

If it is determined that the electronic communication should be rejected (i.e., Yes at D), it is so rejected at E. Typically, rejecting the communication will comprise not delivering any portion of the electronic communication to the recipient(s). Alternatively, the recipient could be notified of the rejection of the communication and given the opportunity to override the rejection. In addition, rejecting the electronic communication may include notifying a sender that it has been rejected. In other embodiments, rejecting the electronic communication may include adding the sender (i.e., source) and/or the contents (e.g., attached or embedded files) to a database of sources and/or contents that should be rejected. For example, if it is determined at D that the electronic communication should be rejected as originating from a source already determined to be illegitimate (e.g., a known spammer), the communication will be rejected at E and the contents of the communication may then be added to a database of contents that should be rejected. This may help in identifying harmful or otherwise undesired contents and preventing them being delivered to recipients, even if they originate from a source not otherwise known to be illegitimate (e.g., where a communication is forwarded from a source that appears to be legitimate but which originated from a source that has already been determined to be illegitimate).

If, on the other hand, it is determined at D that the electronic communication should not be rejected (i.e., No at D), it is delivered to the intended recipient(s) at F.

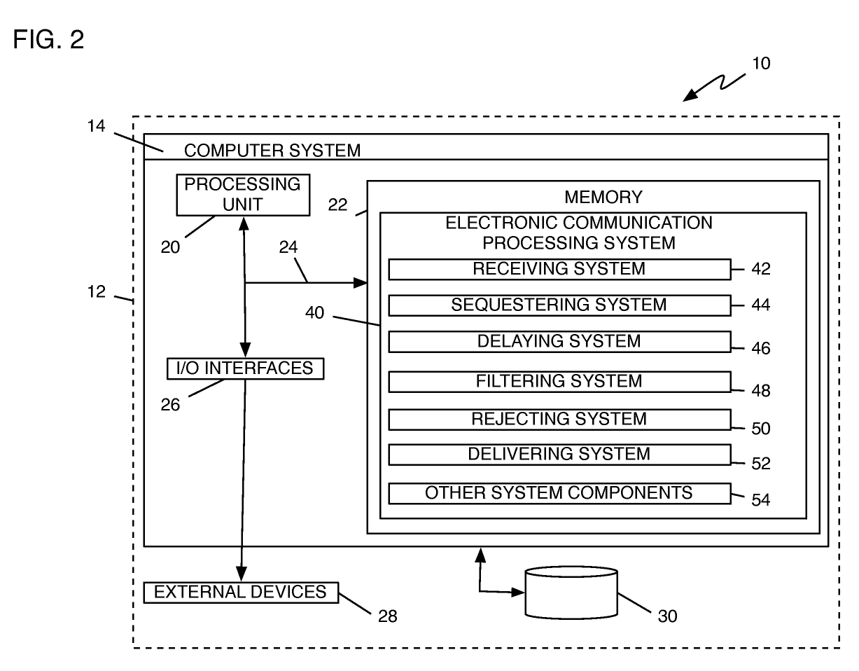

FIG. 2 shows an illustrative system 10 for processing an electronic communication. To this extent, system 10 includes a computer infrastructure 12 that can perform the various process steps described herein for processing an electronic communication. In particular, computer infrastructure 12 is shown including a computer system 14 that comprises an electronic communication processing system 40, which enables computer system 14 to process an electronic communication by performing the process steps of the invention.

Computer system 14 is shown including a processing unit 20, a memory 22, input/output (I/O) interfaces 26, and a bus 24. Further, computer system 14 is shown in communication with external devices 28 and a storage system 30. As is known in the art, in general, processing unit 20 executes computer program code, such as electronic communication processing system 40, that is stored in memory 22 and/or storage system 30. While executing computer program code, processing unit 20 can read and/or write data from/to memory 22, storage system 30, and/or I/O interface 26. Bus 24 provides a communication link between each of the components in computer system 14. External devices 28 can comprise any device that enables a user (not shown) to interact with computer system 14 or any device that enables computer system 14 to communicate with one or more other computer systems.

In any event, computer system 14 can comprise any general purpose computing article of manufacture capable of executing computer program code installed by a user (e.g., a personal computer, server, handheld device, etc.). However, it is understood that computer system 14 and electronic communication processing system 40 are only representative of various possible computer systems that may perform the various process steps of the invention. To this extent, in other embodiments, computer system 14 can comprise any specific purpose computing article of manufacture comprising hardware and/or computer program code for performing specific functions, any computing article of manufacture that comprises a combination of specific purpose and general purpose hardware/software, or the like. In each case, the program code and hardware can be created using standard programming and engineering techniques, respectively.

Similarly, computer infrastructure 12 is only illustrative of various types of computer infrastructures for implementing the invention. For example, in one embodiment, computer infrastructure 12 comprises two or more computer systems (e.g., a server cluster) that communicate over any type of wired and/or wireless communications link, such as a network, a shared memory, or the like, to perform the various process steps of the invention. When the communications link comprises a network, the network can comprise any combination of one or more types of networks (e.g., the Internet, a wide area network, a local area network, a virtual private network, etc.). Regardless, communications between the computer systems may utilize any combination of various types of transmission techniques.

As previously mentioned, the electronic communication processing system 40 enables the computer system 14 to process an electronic communication. To this extent, the electronic communication processing system 40 is shown including a receiving system 42, a sequestering system 44, a delaying system 46, a filtering system 48, a rejecting system 50, and a delivering system 52. Operation of each of these systems is discussed above. The electronic communication processing system 40 may further include other system components 54 to provide additional or improved functionality to the electronic communication processing system 40. It is understood that some of the various systems shown in FIG. 2 can be implemented independently, combined, and/or stored in memory for one or more separate computer systems 14 that communicate over a network. Further, it is understood that some of the systems and/or functionality may not be implemented, or additional systems and/or functionality may be included as part of system 10.

While shown and described herein as a method and system for processing an electronic communication, it is understood that the invention further provides various alternative embodiments. For example, in one embodiment, the invention provides a computer-readable medium that includes computer program code to enable a computer infrastructure to process an electronic communication. To this extent, the computer-readable medium includes program code, such as electronic communication processing system 40, that implements each of the various process steps of the invention. It is understood that the term “computer-readable medium” comprises one or more of any type of physical embodiment of the program code. In particular, the computer-readable medium can comprise program code embodied on one or more portable storage articles of manufacture (e.g., a compact disc, a magnetic disk, a tape, etc.), on one or more data storage portions of a computer system, such as memory 22 and/or storage system 30 (e.g., a fixed disk, a read-only memory, a random access memory, a cache memory, etc.), and/or as a data signal traveling over a network (e.g., during a wired/wireless electronic distribution of the program code).

In another embodiment, the invention provides a business method that performs the process steps of the invention on a subscription, advertising, and/or fee basis. That is, a service provider could offer to process an electronic communication, as described above. In this case, the service provider can create, maintain, support, etc., a computer infrastructure, such as computer infrastructure 12, that performs the process steps of the invention for one or more customers. In return, the service provider can receive payment from the customer(s) under a subscription and/or fee agreement and/or the service provider can receive payment from the sale of advertising space to one or more third parties.

In still another embodiment, the invention provides a method of generating a system for processing an electronic communication. In this case, a computer infrastructure, such as computer infrastructure 12, can be obtained (e.g., created, maintained, having made available to, etc.) and one or more systems for performing the process steps of the invention can be obtained (e.g., created, purchased, used, modified, etc.) and deployed to the computer infrastructure. To this extent, the deployment of each system can comprise one or more of (1) installing program code on a computer system, such as computer system 14, from a computer-readable medium; (2) adding one or more computer systems to the computer infrastructure; and (3) incorporating and/or modifying one or more existing systems of the computer infrastructure, to enable the computer infrastructure to perform the process steps of the invention.

As used herein, it is understood that the terms “program code” and “computer program code” are synonymous and mean any expression, in any language, code or notation, of a set of instructions intended to cause a computer system having an information processing capability to perform a particular function either directly or after either or both of the following: (a) conversion to another language, code or notation; and (b) reproduction in a different material form. To this extent, program code can be embodied as one or more types of program products, such as an application/software program, component software/a library of functions, an operating system, a basic I/O system/driver for a particular computing and/or I/O device, and the like.

The foregoing description of various aspects of the invention has been presented for purposes of illustration and description. It is not intended to be exhaustive or to limit the invention to the precise form disclosed, and obviously, many modifications and variations are possible. Such modifications and variations that may be apparent to a person skilled in the art are intended to be included within the scope of the invention as defined by the accompanying claims.

What is claimed is:

1. A method of processing an electronic communication, the method comprising:
sequestering the electronic communication for a period of time;
determining whether the electronic communication should be rejected based on either or both of its source or its content;
in the case that the electronic communication should be rejected based on either or both of its source or its content, rejecting the electronic communication; and
in the case that the electronic communication should not be rejected based on either or both of its source or its content, delivering the electronic communication to at least one recipient.

2. The method of claim 1, wherein determining includes comparing either or both of the source or the content of the electronic communication with a database of either or both of sources or contents that have been predetermined should be rejected.

3. The method of claim 1, wherein rejecting the electronic communication comprises:
not delivering the electronic communication to a recipient.

4. The method of claim 3, wherein rejecting the electronic communication further comprises at least one of the following:
notifying a sender of the electronic communication that it has been rejected; or
adding at least one of the source or the content of the electronic communication to a database of electronic communication sources and contents that should be rejected.

5. The method of claim 1, wherein determining includes comparing either or both of the source or the content of the electronic communication with a database of either or both of sources or contents that have been predetermined should be delivered.

6. The method of claim 1, wherein the period of time is between about one hour and about 24 hours.

7. The method of claim 6, wherein the period of time is between about one hour and about six hours.

8. The method of claim 7, wherein the period of time is between about one hour and about three hours.

9. The method of claim 1, wherein the electronic communication is selected from a group consisting of: an electronic mail message, an instant messaging message, a text message, a facsimile transmission, and a social networking message.

10. The method of claim 9, wherein the electronic communication is an electronic mail message.

11. A system for processing an electronic communication, the system comprising:
a system for sequestering the electronic communication for a period of time;
a system for determining whether the electronic communication should be rejected based on either or both of its source or its content;
a system for rejecting the electronic communication; and
a system for delivering the electronic communication to at least one recipient.

12. The system of claim 11, further comprising:
a system for comparing either or both of the source or the content of the electronic communication with a database of either or both of sources or contents that have been predetermined should be rejected.

13. The system of claim 11, further comprising:
a system for comparing either or both of the source or the content of the electronic communication with a database of either or both of sources or contents that have been predetermined should be delivered.

14. The system of claim 11, wherein the period of time is between about one hour and about 24 hours.

15. The system of claim 11, wherein the electronic communication is selected from a group consisting of: an electronic mail message, an instant messaging message, a text message, a facsimile transmission, and a social networking message.

16. A program product stored on a computer-readable medium, which when executed, processes an electronic communication, the program product comprising:
program code for sequestering the electronic communication for a period of time;
program code for determining whether the electronic communication should be rejected based on either or both of its source or its content;
program code for rejecting the electronic communication; and
program code for delivering the electronic communication to at least one recipient.

17. The program product of claim 16, further comprising:
program code for comparing either or both of the source or the content of the electronic communication with a database of either or both of sources or contents that have been predetermined should be rejected.

18. The program product of claim 16, further comprising:
program code for comparing either or both of the source or the content of the electronic communication with a database of either or both of sources or contents that have been predetermined should be delivered.

19. The program product of claim 16, wherein the electronic communication is selected from a group consisting of: an electronic mail message, an instant messaging message, a text message, a facsimile transmission, and a social networking message.

20. A method for deploying an application for processing an electronic communication, comprising:
providing a computer infrastructure being operable to:
sequester the electronic communication for a period of time;
determine whether the electronic communication should be rejected based on either or both of its source or its content;
in the case that the electronic communication should be rejected based on either or both of its source or its content, reject the electronic communication; and
in the case that the electronic communication should not be rejected based on either or both of its source or its content, deliver the electronic communication to at least one recipient.
